(19) United States
(12) Patent Application Publication
(10) Pub. No.: US 2025/0207753 A1
(43) Pub. Date: Jun. 26, 2025

(54) HEADLAMP FOR VEHICLES AND ANTI-CONDENSATION PROCESS

(71) Applicant: Hella GmbH & Co. KGaA, Lippstadt (DE)

(72) Inventors: Hamza Akin, Lippstadt (DE); Maximilian Mevenkamp, Hamm (DE); Andreas Lintz, Lippstadt (DE)

(21) Appl. No.: 19/079,014

(22) Filed: Mar. 13, 2025

Related U.S. Application Data
(63) Continuation of application No. PCT/EP2023/074868, filed on Sep. 11, 2023.

(30) Foreign Application Priority Data
Sep. 19, 2022 (DE) 10 2022 123 961.6

(51) Int. Cl. F21S 45/60; B60Q 1/08; F21S 41/20; F21S 41/663; F21V 23/04

(52) U.S. Cl. CPC F21S 45/60; B60Q 1/085; F21S 41/2805; F21S 41/663; F21V 23/0442; B60Q 2300/31

(57) ABSTRACT

A headlamp for vehicles has a housing containing a light source unit with numerous light sources, and an optical unit for generating a predefined light distribution. A cover lens covers a light-emitting aperture in the housing. A control unit is provided for the light sources. An anti-condensation means prevents condensation on a surface of the optical unit and/or the cover lens. The control unit contains a control program to operate the light source unit at an anti-condensation level higher than the normal level for generating the predefined light distribution. The difference between the anti-condensation level and the normal level is great enough that a relative humidity within the housing in an anti-condensation state is lower than in the normal state. Light sources in the light source unit that are not intended for generating the predefined light distribution are also switched on, in addition to those intended for such.

### CROSS REFERENCE

This application claims priority to PCT Application No. PCT/EP2023/074868, filed Sep. 11, 2023, which itself claims priority to German Application No. 10 2022 123961.6, filed Sep. 19, 2022, the entireties of both of which are hereby incorporated by reference.

### FIELD OF THE INVENTION

The invention relates to a headlamp for vehicles that has a housing containing a light source unit with numerous light sources and an optical unit for generating a predefined light distribution, which has a cover lens for a light-emitting aperture in the housing, a control unit for the light sources, and an anti-condensation means for preventing condensation on a surface of the optical unit and/or the cover lens.

The invention also relates to a method for preventing condensation on a surface of the optical unit in the headlamp.

### BACKGROUND OF THE INVENTION

In order to function properly, the air humidity inside the headlamp must be kept low enough that condensation does not accumulate on the surfaces of the optical components such as the cover lens. This condensation can have a negative impact on the light distribution generated by the headlamp.

DE 197 33 000 A1 discloses the use of a heating element near the surface of an optical component to keep it dry.

DE 10 2006 006 099 A1 discloses the use of supplementary desiccants to limit the humidity in the interior air.

DE 10 2020 007 598 A1 discloses a headlamp for vehicles that has a housing containing a light source unit and optical unit for generating a predefined light distribution. The light source unit contains a printed circuit board populated with numerous LEDs. A light-emitting aperture in the housing is covered by a cover lens. To prevent condensation on the cover lens, the anti-condensation means comprises numerous infrared light sources on the printed circuit board populated by the LEDs. Both the infrared light sources and the LEDs are arranged in a matrix composed of rows and columns on the printed circuit board, in which the LED and infrared light sources alternate in both the rows and columns. The disadvantage with this is that the size of the light source unit is substantially increased due to the addition of the infrared light sources, having a negative impact on the light distribution.

### BRIEF SUMMARY OF THE INVENTION

The object of the present invention is to therefore develop a headlamp for vehicles and a method for preventing condensation, such that undesired condensation on optical surfaces of the headlamp can be prevented in a space-saving and simple manner.

In an example embodiment, a control unit contains a control program with which the light source unit is operated at an anti-condensation level that is higher than the normal level for generating a predefined light distribution, in which the difference between the two levels is great enough that a relative humidity within the housing at the anti-condensation level is lower that during the normal operation, and there are light sources in addition to those for generating the predefined light distribution in the light source unit that are also switched on.

This results in an invention with which condensation can be prevented on optical surfaces in a headlamp housing that requires no additional components and has no impact on the light distribution. The fundamental concept of the invention is to switch on light sources not needed for the current driving conditions (light distribution), in order to increase the thermal output of a light source unit such that an undesired condensation on optical surfaces of the headlamp housing is prevented. To achieve this, the control unit for the light sources in the light source unit contains a program with which light sources for generating the predefined light distribution as well as light sources not intended for this predefined light distribution are switched on, such that the light source unit is operated at a heightened anti-condensation level instead of the normal level. This heightened anti-condensation level results in a higher thermal output from the light source unit with which condensation on the optical surfaces, in particular the cover lens for the housing, is prevented. A portion of the light source unit that is not otherwise used can be advantageously used for this anti-condensation purpose.

According to a preferred embodiment of the invention, the light sources in the light source unit are controlled such that at least part of the light sources not intended for generating the predefined light distribution are switched on while the vehicle is in use, in particular during the daytime. If only a daytime running lights function is to be generated during the daytime, additional light sources are switched on that are intended for a low beam light distribution. This is advantageously simple, because only those light sources intended for this light distribution need to also be switched on.

According to another aspect of the invention, these additional light sources, not needed for the predefined light distribution, are switched on, such that the relative humidity inside the housing is reduced by at least 10%, preferably 30% from the normal state in which only the light sources for the intended light distribution are switched on. By keeping the light sources not intended for the predefined light distribution on, the humidity level inside the housing is kept to a relatively low level, thus preventing condensation on the optical surfaces, in particular during changes in the weather conditions, which would otherwise result in an abrupt increase in humidity.

According to one embodiment of the invention, the light sources in the light source unit not intended for the predefined light distribution are switched on for a predefined anti-condensation period while the vehicle is travelling. If the travel time is longer than this anti-condensation period, these light sources are subsequently switched off. The anti-condensation period is long enough that condensation is not likely to accumulate on the optical surfaces.

According to one embodiment of the invention, light sources in the light source unit are switched on when the vehicle is parked, in order to restrict the humidity inside the headlamp by exploiting the thermal output thereof. In public areas, the positioning light can be used for this. In private areas, e.g. a garage, light sources can be switched on that are used for generating daytime running lights and/or a low beam light distribution.

According to one embodiment of the invention, there is a humidity sensor inside the housing with which the humidity in the interior can be detected. If the humidity detected by the humidity sensor reaches a predefined humidity threshold, at least part of the light sources not intended for the current light distribution are switched on. Advantageously, the length of time that these light sources are switched on, resulting in addition power consumption, can be reduced by this means.

According to another embodiment of the invention, the control unit is coupled to a weather data base, and/or a location data base, and/or a seasonal data base, such that the light sources in the light source unit can be switched on to prevent condensation based on the current weather, and/or current location, and/or current season. This optimizes the anti-condensation effect, because the light sources not intended for the predefined light distribution are switched on longer if the weather data base indicates current weather conditions with increased humidity. The seasonal information can be used, for example, to ensure that the lights not intended for the predefined light distribution are left on for less time during a dry winter than during a humid summer.

The method obtained with the invention advantageously enables the use of the light source unit not only for generating a predefined light distribution, but also results in a thermal output for avoiding condensation on optical surfaces of the headlamp housing. No changes are made to the light source unit. Only an additional activation of light sources not intended for the light distribution takes place.

According to another aspect of the method obtained with the invention, switching the light sources on that are not intended for the light distribution takes place on the basis of weather information, and/or location information, and/or seasonal information. In this manner, the increased thermal output of the light source unit for preventing condensation can be optimized to current environmental conditions.

According to another aspect of the invention, the other light sources, which are not intended for generating the predefined light distribution, are light sources intended for another operating state, specifically for generating another light distribution. The other light sources may be intended for generating a subsidiary light distribution, e.g. a close range light distribution. Consequently, this is a simple means of protecting against condensation, because there are no supplementary light sources that are not intended for generating some predefined light distribution.

According to another aspect of the invention, the time during which the other light sources are switched on is such that the current humidity in the air inside the headlamp is lower than a predefined condensation threshold. This period of time is preferably selected to ensure that the humidity inside the headlamp always remains below the condensation threshold. This safety buffer results in preventing undesired condensation of the optical surfaces to a high probability.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a block diagram of a first embodiment of a headlamp obtained with the invention.

FIG. 2 shows a graph plotting a humidity curve inside a headlamp during normal operation and when condensation occurs.

FIG. 3 shows a block diagram of a second embodiment of the headlamp.

FIG. 4 shows a block diagram of a third embodiment of the headlamp.

### DETAILED DESCRIPTION OF THE DRAWINGS

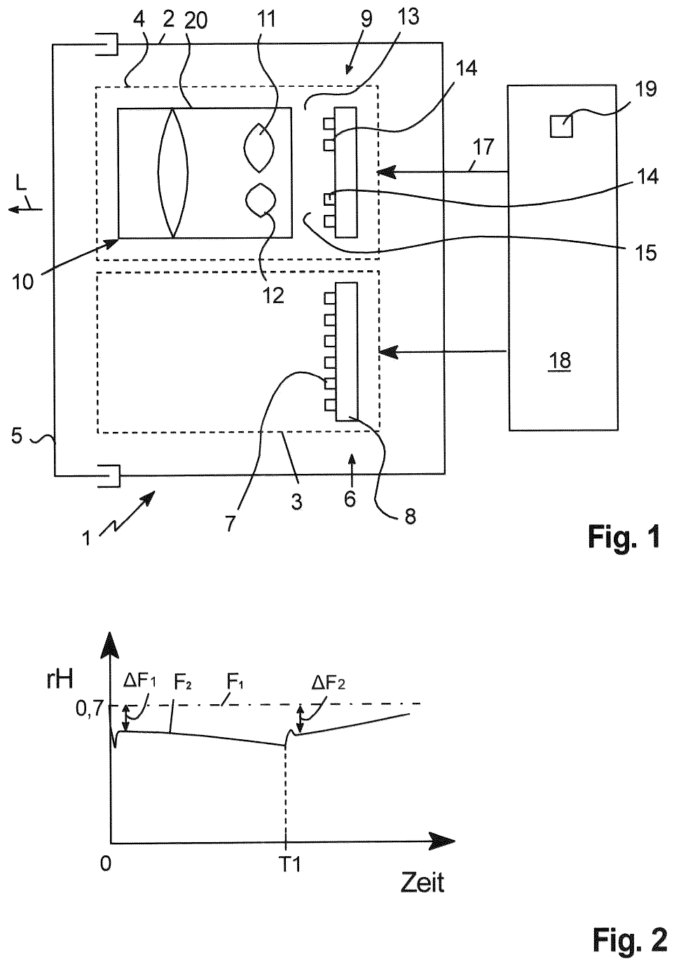

A first embodiment of a headlamp 1 obtained with the invention is shown in FIG. 1, which has a housing 2 that contains a first light module 3 and second light module 4. A light-emitting aperture in the housing 2 is covered by a transparent lens 5.

The first light module 3 only contains one light source unit 6 with numerous light sources 7 arranged in a matrix, with which a daytime running light distribution is generated when they are switched on. The light sources 7 populate a single printed circuit board 8. The light sources 7 are LEDs.

The second light module 4 generates a low beam light distribution and/or high beam light distribution. The second light module 4 contains a light source unit 9 and an optical unit 10. The optical unit 10 comprises a lens 16 in the front of the headlamp 1 in the direction L in which light is emitted on a side facing the cover lens 5. It also contains a first primary lens 11 for a first part 13 of the light sources 14 arranged in a matrix, and second primary lens 12 for a second part 15 of the light sources 14 in the light source unit 9. The first primary lens 11 is designed to direct the first part 13 of the light sources 14 such that light emitted therefrom forms a close range light distribution emitted through the lens 16. The second primary lens 12 is designed to direct light emitted from the second part 15 of the light sources 14 such that a far field light distribution is emitted through the lens 16.

The second light module 4 generates a low beam light distribution, forming the first predefined light distribution, and a high beam light distribution, forming the second predefined light distribution. When only the first part 13 of the light sources 14 are switched on by a control signal 17 from an electronic control unit 18, the light distribution is generated as a low beam light distribution in the near field. If the second part 15 of the light sources 14 is also switched on, the high beam light distribution is generated, which is formed by superimposing it on the near field light distribution.

To prevent condensation on optical surfaces of the housing 2, particularly the cover lens 5, the control unit 18 contains a program 19 with which supplementary light sources 14, which are not used to generate the predefined light distribution, are switched on, in addition to those light sources 7, 14 that are used to generate the predefined light distribution. By way of example, the predefined light distribution for daytime driving is the daytime running light distribution obtained by switching on the first light module 3. The control program 19 can be designed to switch on the first part 13 of the light sources 14 in the second light module 14 during the daytime, such that in comparison with the normal operation of the headlamp, in which only the first light module 3 is switched on, a greater thermal output is obtained within the housing 2 (housing interior). FIG. 2 shows a graph indicating the humidity in the headlamp 1 when the first part 13 of the light sources 14 is switched off and when it is switched on. When the first part 13 of the light sources 14 is off, the humidity F₁ remains at a constant level, e.g. 0.7, when ideal driving conditions are assumed. When the first part 13 of the light sources 14 is switched on, a humidity curve F₂ is obtained in the interior, which is substantially lower than the humidity F₁ obtained when this part 13 is switched off. It can be assumed that the first part 13 of the light sources 14 is switched on during daytime operation until reaching the point in time T₁, when the vehicle is parked. It can be seen that after switching these light sources 14 on at a point in time 0, the humidity in the housing decreases abruptly by ΔF. The humidity difference ΔF increases over time during daytime operation. After parking the vehicle and switching the first part 13 of the light sources 14 off, the humidity increases abruptly, resulting in a second humidity difference ΔF₂. This humidity difference decreases continuously over time.

It is clear that by switching the first part 13 of the light sources 14 on, which are not intended for the predefined daytime running light distribution, the relative humidity in the housing is substantially reduced. It is clear that ΔF1 is 0.2, such that when the vehicle is traveling, the reduction in humidity is at least 30%, and a humidity reduction of 10% from the state when they were switched off at F₁ is still obtained after stopping the vehicle at time T₁.

Longer travel times result in higher humidity differences ΔF₂ after stopping the vehicle. As FIG. 2 shows, the vehicle is in an anti-condensation state when it is travelling, during which the anti-condensation level ΔF₁ increases continuously in comparison with the normal level (when the second light module 4 is switched off). After stopping the vehicle at time T₁, the anti-condensation level approaches the normal level, as the humidity difference ΔF₂ decreases, while the overall difference ΔF to the humidity level F₁ is greater. With greater driving frequency, or shorter pauses between driving, the reduction in humidity, or prevention of condensation, is greater.

In an alternative embodiment of the invention, which is not illustrated, the anti-condensation state can be limited to a specific time period. This is particularly the case with drivers who travel relatively often.

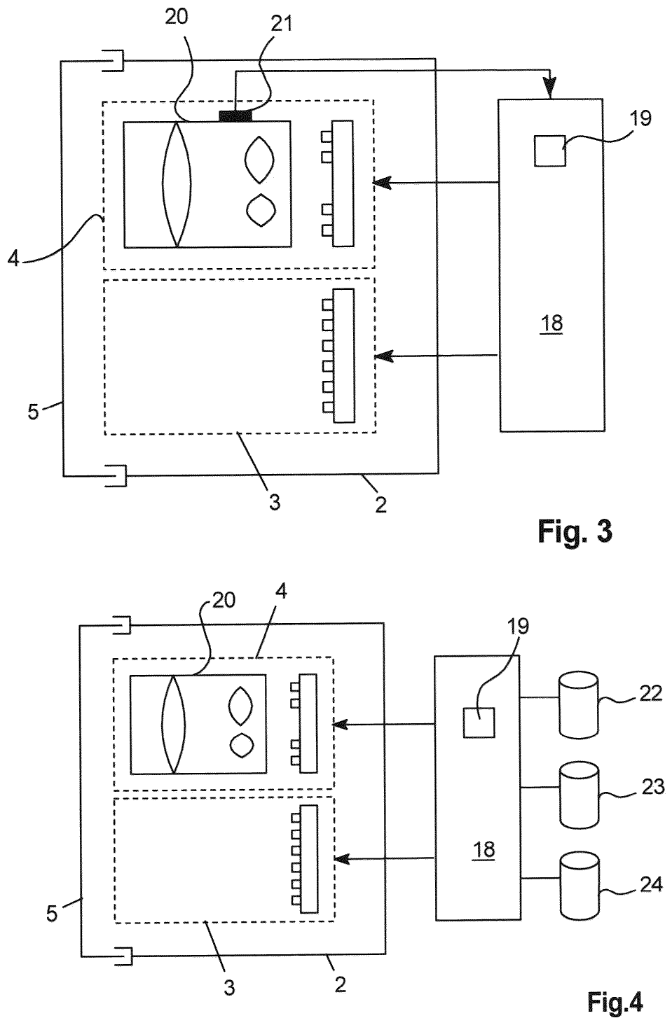

In another embodiment of the invention that is shown in FIG. 3, a humidity sensor 21 that generates a humidity signal evaluated by the control unit 18 is attached to a mounting frame 20 for the second light module 4, which contains the primary lenses 11, 12, and the lens 16. The second light module 4, or the first part 13 of the light source unit 9, is switched on based on this humidity signal from the humidity sensor 21 during daytime operation.

According to a third embodiment of the invention, shown in FIG. 4, the control unit 18 is connected to a weather data base 22, a location data base 23, and a seasonal data base 24. Alternatively, the control unit 18 can be coupled to just one or two of the aforementioned data bases.

The weather data base 22 provides current weather data and forecasts for the following day. The weather data can contain relative humidity data, for example. In some humidity can also be calculated from the weather data. If the weather data base 22 provides data with a relatively high humidity, which is higher than a humidity threshold, the first part 13 of the light sources 7 is switched on during daytime travel. If the current weather data indicates that the air is relatively dry, this part 13 of the light sources 7 is not switched on during the daytime. The weather data can be obtained through a communication network, e.g. a cellular telephone network, etc.

The location data base 23 can extract location data from the navigation system in the vehicle. Locations and regions can be listed in the location data base with typical humidity conditions. By comparing the current location of the vehicle with the list of the humidities associated with respective locations, it can be determined whether the first part 13 of the light sources needs to be switched on or not.

The seasonal data base 24 contains humidity levels associated with different seasons of the year. The contents of the seasonal data base 24 can be combined with the location data base 23 in order to decide whether the first part 13 of the light sources 7 needs to be switched on or not, based on the current location and the current season, using empirical values.

### LIST OF REFERENCE SYMBOLS

1 headlamp
2 housing
3 first light module
4 second light module
5 cover lens
6 light source unit
7 light sources
8 printed circuit board
9 light source unit
10 optical unit
11 first primary lens
12 second primary lens
13 first part
14 light source
15 second part
16 lens
17 control signal
18 control unit
19 control program
20 mounting frame
21 humidity sensor
22 weather data base
23 location data base
24 seasonal data base
F₁, F₂ humidity curves
T₁ point in time
ΔF, ΔF₂ humidity difference
ΔF₁ anti-condensation level

1. A headlamp for vehicles, the headlamp comprising:
a housing containing a light source unit with a plurality of light sources, the housing also containing an optical unit for generating a predefined light distribution;
a cover lens that covers a light-emitting aperture in the housing;
a control unit for the light sources; and
an anti-condensation means for preventing condensation on a surface of the optical unit and/or the cover lens,
wherein the control unit contains a control program with which the light source unit is operated at an anti-condensation level, which is higher than the normal level for generating the predefined light distribution,
wherein the difference between the anti-condensation level and the normal level is great enough that a relative humidity within the housing in an anti-condensation state is lower than in the normal state,
wherein light sources in the light source unit that are not intended for generating the predefined light distribution are also switched on, in addition to those intended for such.

2. The headlamp according to claim 1, wherein the control program switches on at least part of the light sources not intended for generating the predefined light distribution while the vehicle is travelling, in particular during daylight hours.

3. The headlamp according to claim 1, wherein the control program switches on the first part of the light sources at the anti-condensation level such that the relative humidity within the housing when they are switched on is reduced by at least 10% in comparison with the normal level.

4. The headlamp according to claim 1, wherein the control program is configured such that the relative humidity (rH) within the housing when the light source unit is switched on decreases continuously, and increases continuously after the light source unit is switched off.

5. The headlamp according to claim 1, wherein the control program is configured such that the light source unit is always operated at the anti-condensation level when the vehicle is travelling for a predefined period of time.

6. The headlamp according to claim 1, wherein the control program is configured such that the light source unit is operated at the anti-condensation level when the vehicle is parked.

7. The headlamp according to claim 1, wherein the control unit is coupled to a humidity sensor inside the housing, and the light source unit is operated at an anti-condensation level that is higher than the normal level as soon as the humidity sensor detects a humidity level that is higher than a predefined humidity threshold.

8. The headlamp according to claim 7, wherein the light source unit and optical unit are contained in a module housing or attached to a mounting frame, wherein the humidity sensor is attached to the module housing or the mounting frame.

9. The headlamp according to claim 1, wherein the control unit is coupled to a weather data base, and/or a location data base, and/or a seasonal data base, such that the control signal for the light sources is generated based on current weather conditions, and/or the current location, and/or the current season.

10. The headlamp according to claim 1, wherein there are numerous light modules, wherein a first light module generates a daytime running light distribution, and a second light module generates a near field light distribution and a far field light distribution, wherein during daylight, the light sources in the second light module for generating the near field light distribution are added to the light sources in the first light module.

11. A method for preventing condensation on a surface of an optical component in a headlamp according to claim 1, wherein in addition to the light sources with which the predefined light distribution is generated while the vehicle is in operation, additional light sources are switched on with which additional heat is generated by the light source unit.

12. The method according to claim 11, wherein the additional light sources are switched on based on humidity data detected inside the housing for the headlamp, and/or current weather data, and/or current location data, and/or current seasonal data.

13. The method according to claim 11, wherein the additional light sources generate a predefined light distribution or a supplementary light distribution when they are switched on.

14. The method according to claim 11, wherein the additional light sources are switched on for a period selected such that the current humidity level inside the headlamp housing remains below the condensation threshold.

15. The method according to claim 11, wherein the light sources are switched on such that the additional light sources are switched on while the vehicle is travelling and/or while the vehicle is parked.

16. The headlamp according to claim 2, the control program switches on at least part of the light sources not intended for generating the predefined light distribution while the vehicle is travelling during daylight hours.
